(19) United States
(12) Patent Application Publication
(10) Pub. No.: US 2011/0026249 A1
(43) Pub. Date: Feb. 3, 2011

(54) Low profile LED lighting assembly

(76) Inventors: Jonathan Wylde, Mississauga (CA); Wendell Ng-See-Quan, Toronto (CA); Winfield Ng-See-Quan, Toronto (CA)

Correspondence Address: LITMAN LAW OFFICES, LTD., PATENT LAW BUILDING, 8955 CENTER STREET, MANASSAS, VA, 20110, US

(21) Appl. No.: 12/461,109

(22) Filed: Jul. 31, 2009

(51) Int. Cl. F21V 11/00; F21V 1/00

(52) U.S. Cl. 362/240; 362/241

(57) ABSTRACT

The Low profile LED lighting assembly includes a housing, a circuit board, a plurality of LEDs, and a plurality of reflector assemblies. The circuit board provides wiring and power to thirty-two LEDs arranged in the housing. Each LED is surrounded by a reflector assembly and arranged within the housing to provide a relatively uniform and bright central region to illuminate a predetermined space beneath the device. Each LED and reflector assembly is adapted to illuminate a portion of the total target area. The reflector assembly has five asymmetrical facets surrounding each LED to direct the LED light output to a region within the narrow region of the target space. Repetition of this arrangement results in a light distribution pattern that covers the entire target area.

### BACKGROUND OF THE INVENTION

1. Field of the Invention

The present invention relates generally to illumination devices, and particularly to a low profile LED lighting assembly having an arrangement of reflectors designed for high efficiency illumination of a target area.

2. Description of the Related Art

It is desirable to provide generally uniform illumination when illuminating a target area in an indoor parking. Parking lot designers typically specify a minimum luminance required throughout the target area. Additionally, it is desirable to design a lighting assembly having a lux profile that does not exceed the specified minimum luminance at locations within the target area.

Thus, a pattern of uniform distribution of light within the target area is desirable to reduce the amount of energy required for illumination of the entire target area.

Given the fact that Illumination follows the well-known inverse square law, designers often incorporate reflectors to redirect light towards peripheral spots within a target area to be illuminated.

Light emitting diodes are typically designed in array format, since they are generally not powerful enough to be used as a point light source that could be appropriately reflected to compensate for the inverse square law. Moreover, LEDs typically do not emit light in a spherical pattern, such as incandescent and arc-type lamps, thus making it difficult to design an appropriate reflector.

To provide sufficient illumination for the target area multiple LEDs are required to provide the sufficient amount of lumens for the target area. An array of LEDs is typically mounted on a printed circuit board (“PCB”). However, the size of the PCB required and the number of LEDs required makes it difficult to consider the plurality of LEDs in aggregate as a single point light source. In view of this, it has been known to provide separate optics, either refractive of reflective, for each LED to redirect the light emanating from each LED. Providing a separate optic for each LED can be expensive, and also makes design of the fixture difficult, especially where it is desirable to provide a light fixture that is easily scalable so that it can be used in a number of different applications.

Thus, a low profile LED lighting assembly solving the aforementioned problems is desired.

### SUMMARY OF THE INVENTION

The low profile LED lighting assembly includes a housing, a circuit board, a plurality of LEDs, and a plurality of reflector assemblies. The circuit board provides wiring and power to thirty-two LEDs arranged on a first surface of the housing. Each LED is surrounded by a reflector assembly and arranged within the housing to provide a relatively uniform and bright central region to illuminate a predetermined space beneath the device. Each LED and reflector assembly is adapted to illuminate a narrow region of the target space. The reflector assembly has five asymmetrical facets surrounding each LED to direct the LED light output to a region within the narrow region of the target space. Repetition of this arrangement results in a light distribution pattern that covers the entire target space below the device.

These and other features of the present invention will become readily apparent upon further review of the following specification and drawings.

### BRIEF DESCRIPTION OF THE DRAWINGS

FIG. 1 is a bottom perspective view of a low profile LED lighting assembly according to the present invention.

FIG. 2 is a bottom view of a low profile LED lighting assembly according to the present invention.

FIG. 3 is a side view in section of a low profile LED lighting assembly according to the present invention, the assembly being inverted.

FIG. 4 is a top perspective view of a low profile LED lighting assembly according to the present invention.

FIG. 5 is a graph showing illumination properties of a low profile LED lighting assembly according to the present invention.

Similar reference characters denote corresponding features consistently throughout the attached drawings.

### DETAILED DESCRIPTION OF THE PREFERRED EMBODIMENTS

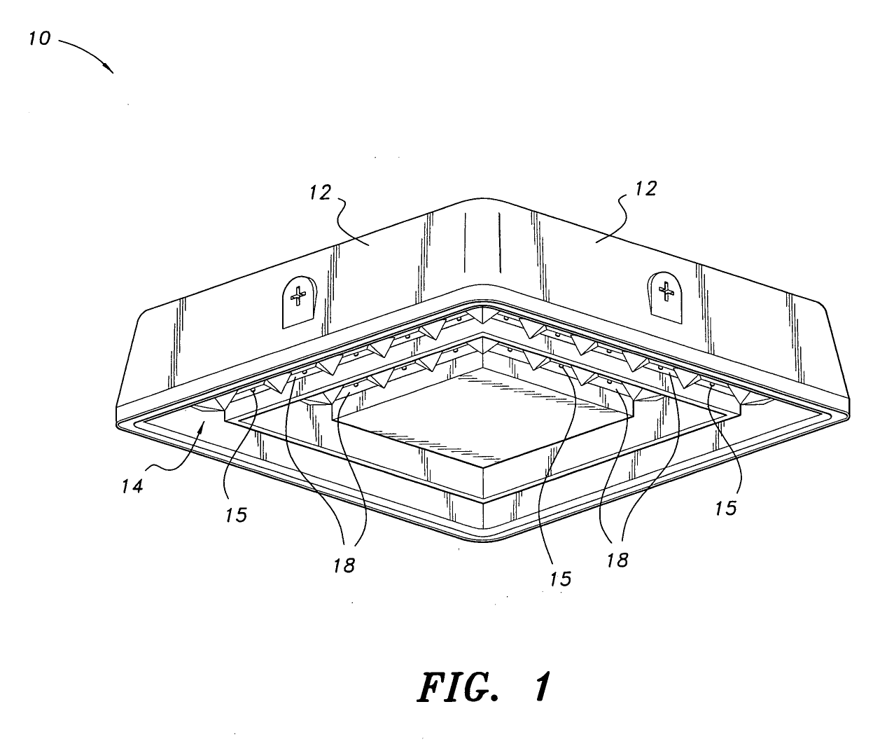

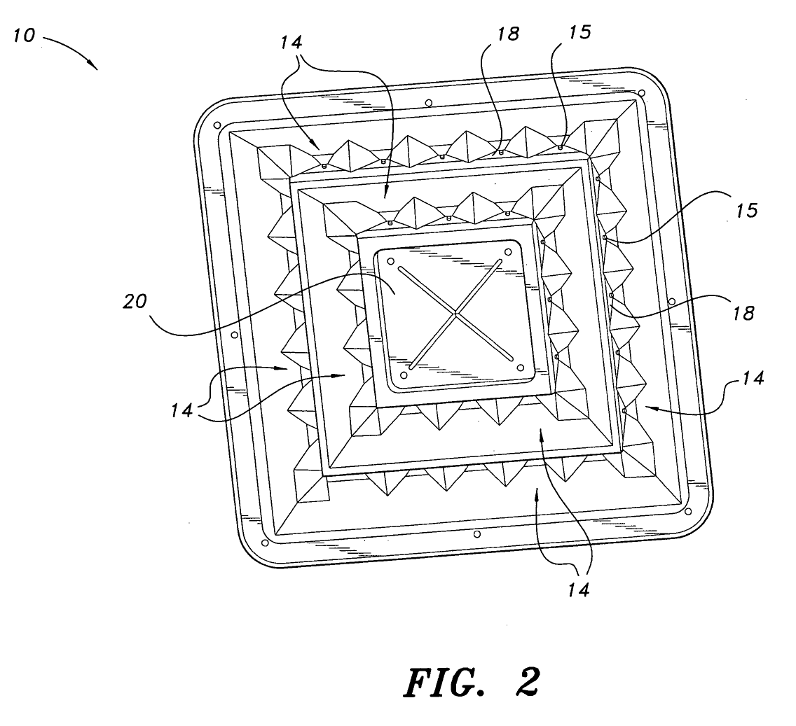

As shown in FIGS. 1-4, the low profile LED lighting assembly 10 has a substantially square-shaped hood or housing defined by peripheral walls 12, and also includes LED circuit boards 18, LEDs 15, and reflector assemblies 14. As most clearly shown in FIG. 2, the lower side of lighting assembly 10 includes a square-shaped, central planar member 20 disposed in the interior of the housing that has no light sources. An inner four-sided ring configuration of twelve LED lights 15 alternating with twelve reflector assemblies 14 is disposed in concentric relation around the periphery of planar member 20. An outer four-sided ring configuration of twenty LED lights 15 alternating with twenty reflector assemblies 14 is disposed in concentric relation around the inner four-sided ring configuration of twelve LED lights 15 and twelve reflector assemblies 14. Thus, the pattern of light from lighting assembly 10 is sourced by thirty two LED lights 15, preferably Nichia LEDs, mounted on circuit boards 18, which provide wiring and power to the thirty two LED lights 15 arranged on the lower side of lighting assembly 10. The LED lights 15 are arranged so that each LED light 15 points outward towards a reflector in a reflector assembly 14 and not directly downward towards the target area.

Each reflector assembly 14 has five asymmetrical planar facets surrounding each LED 15 to direct the output of LED light 15 to a portion of the total target space. Repetition of reflector assembly 14, i.e., a plurality of reflector assemblies 14, results in an inexpensive way to distribute a light pattern that covers the entire target space below the lighting assembly 10.

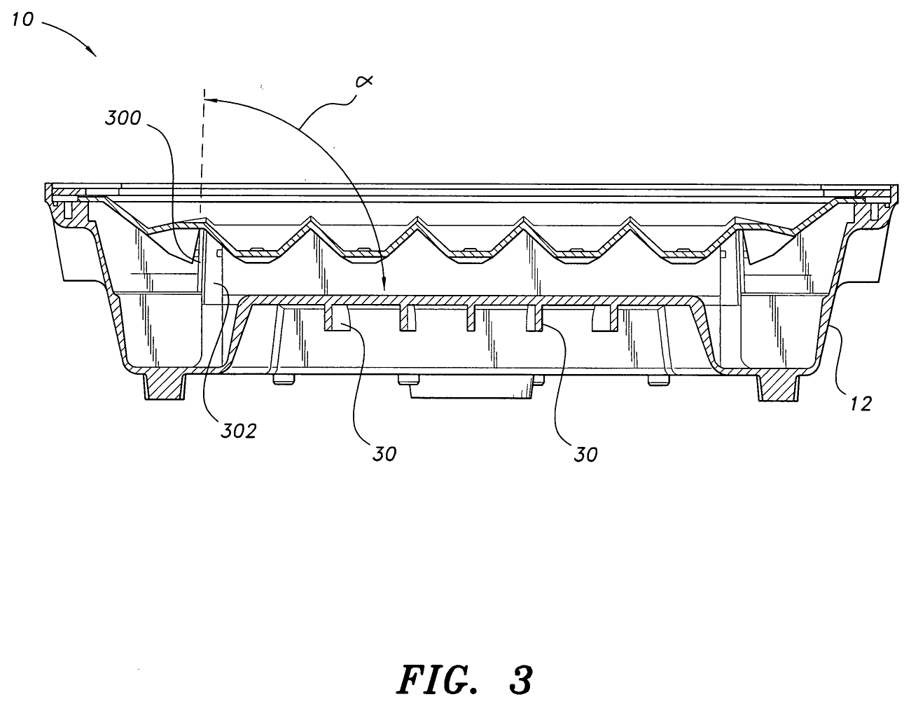

As shown in FIG. 3, a printed circuit board (PCB) platform 302 is constructed so that the LED circuit board 18 lies in a plane 300 that is canted at a predetermined dihedral angle α of less than 90°, and most preferably at a dihedral angle of 87°, relative to a plane parallel to planar member 20 and the top wall of the housing in order to cast a substantial portion of the source LED light 15 mounted on circuit board 18 (shown in FIG. 2) outward in a beam that is directed away from areas directly under the LED 15. This geometry is repeated for all PCB assemblies 18. Unreflected light emitted by LED lights 15 is sufficient to adequately illuminate portions of the target area directly under the lighting assembly 10.

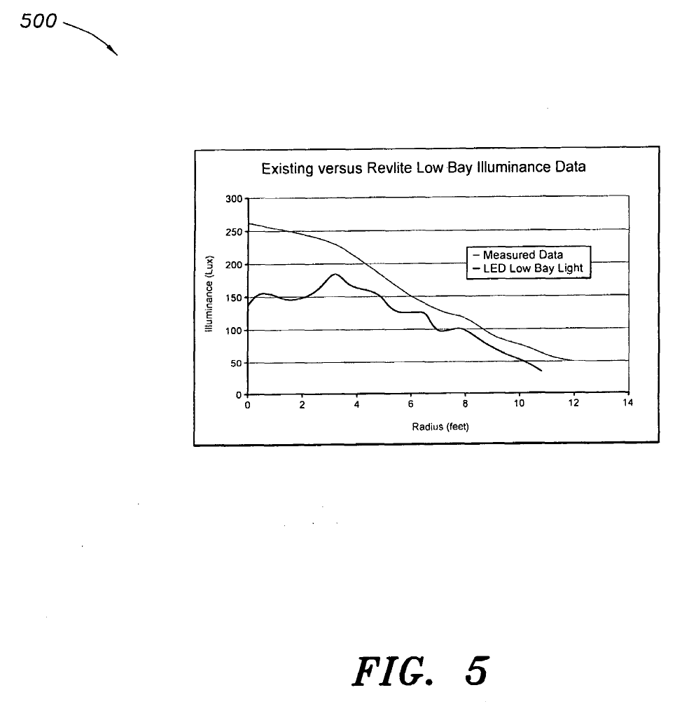

The aforementioned arrangement of each LED 15 in relation to each reflector assembly 14 provides a relatively uniform and bright central region to illuminate a predetermined target area beneath the device. The lux distribution is illustrated in plot 500 of FIG. 5.

The lighting assembly 10 has been designed with DTO (Digitally Tuned Optical) Technology, which assigns an area in space that each LED 15 must illuminate. DTO technology may utilize ray tracing software to determine optimum configuration of reflector assemblies. Designing LED lighting assembly 10 via DTO technology leads to optimum illumination without any hot spots, no glare for oncoming traffic, and minimum energy use. The beam angle α may be determined via the aforementioned DTO-technology reflector design.

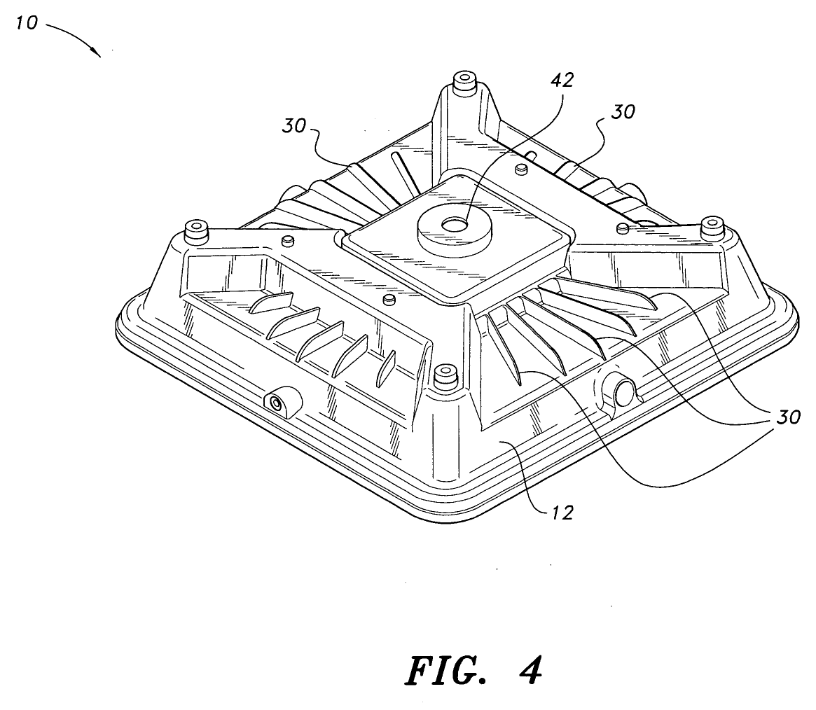

The LED PC boards 18 include a thermal management system that shuts down power to the lighting assembly 10 if the environment experiences a sudden or consistently high over-temperature condition, i.e., fire, air conditioner failure, or the like. In the event of a power outage, the restrike time of the low profile LED lighting assembly 10 is in nanoseconds, without incurring any damage. Moreover, the lighting assembly 10 is RoHS compliant, and is a direct LED replacement for box-styled cobra head, acorn, and dropdown parking garage lighting systems. As shown in FIGS. 3-4, a plurality of elongate heat fins 30 extend radially from a central region of the mounting or upper side of lighting assembly 10. A mounting bore 42 is disposed at a geometric center of the lighting assembly 10.

The lighting assembly 10 is designed to be used with most existing power supplies. However, a 347-Volt step-down transformer is available for high voltage applications.

The lighting shell or housing is preferably aluminum with an “electronic” finish. A typical lighting assembly 10 has dimensions of 15″×15″. The low profile height of lighting assembly 10 is approximately 3¾ inches.

It is to be understood that the present invention is not limited to the embodiment described above, but encompasses any and all embodiments within the scope of the following claims.

We claim:

1. A low profile LED lighting assembly, comprising:
a housing having a top wall and a plurality of peripheral sidewalls extending from the top wall, defining an open bottom and interior of the housing;
a square-shaped central region disposed in the interior of the housing and facing downward through the open bottom of the housing, the central region having no light sources;
an inner four-sided ring configuration of alternating LED lights and reflector assemblies disposed in concentric relation around the central region, each of the LED lights of the inner ring being adjacent to a respective pair of the reflector assemblies, each of the inner ring reflector assemblies having a plurality of facets; and
an outer four-sided ring configuration of alternating LED lights and reflector assemblies disposed in concentric relation around the inner ring of LED lights and reflector assemblies, each of the LED lights of the outer ring being adjacent to a respective pair of the reflector assemblies, each of the outer ring reflector assemblies having a plurality of facets;
wherein each of the LED lights in the inner and outer rings directly faces a facet of one of the adjacent reflector assemblies, instead of directly facing a target area of illumination, so that light emitted by the LED is incident to the facing facet; and
wherein the LED is mounted in a plane forming a dihedral angle α relative to the top wall, the angle α being less than 90°.

2. The low profile LED lighting assembly according to claim 1, wherein the inner ring of alternating LED lights and reflector assemblies has three LED light-reflector assemblies per side.

3. The low profile LED lighting assembly according to claim 1, wherein the outer ring of alternating LED lights and reflector assemblies has five LED light-reflector assemblies per side.

4. The low profile LED lighting assembly according to claim 1, wherein each of the reflector assemblies has five facets.

5. The low profile LED lighting assembly according to claim 1, wherein all of the reflector assemblies are geometrically identical.

6. The low profile LED lighting assembly according to claim 1, further comprising a thermal management system having means for shutting down power to the LED lights when sudden over-temperature conditions and when consistently high over-temperature conditions are encountered.

7. The low profile LED lighting assembly according to claim 1, further comprising a plurality of elongate heat fins extending radially on the top wall opposite the open bottom.

8. The low profile LED lighting assembly according to claim 1, further comprising a mounting bore defined in said housing.

9. The low profile LED lighting assembly according to claim 1, wherein the housing is made of aluminum.

10. The low profile LED lighting assembly according to claim 1, wherein the total height of the housing is approximately three and three-quarter inches.

11. The low profile LED lighting assembly according to claim 1, wherein the dihedral angle α is 87°.
